(19) United States
(12) Patent Application Publication
(10) Pub. No.: US 2023/0115783 A1
(43) Pub. Date: Apr. 13, 2023

(54) Electrically Operated Gas Flow Regulating Valve

(71) Applicant: RINNAI CORPORATION, Aichi (JP)

(72) Inventor: Kotaro Kuzuya, Aichi (JP)

(73) Assignee: RINNAI CORPORATION, Aichi (JP)

(21) Appl. No.: 17/940,571

(22) Filed: Sep. 8, 2022

(30) Foreign Application Priority Data
Oct. 12, 2021 (JP) 2021-167400

(51) Int. Cl. F16K 31/04; F16K 31/528; F16K 31/524; F16K 3/22

(52) U.S. Cl. CPC F16K 31/047; F16K 31/5286; F16K 31/52475; F16K 3/22

(57) ABSTRACT

A flow regulating valve in which a needle valve body is arranged to be moved axially by a motor through a motion conversion mechanism. The motion conversion mechanism has: a guide member having formed therein axially elongated slits with which cam pins fixed to the needle valve body are slidably engaged, the guide member being coupled to the motor; and a cam body having formed spirally shaped cam parts with which the cam pins are engaged such that the cam body is prevented from rotating relative to a valve casing. The valve casing includes inside thereof a deformation-restricting element having a female type of fitting part into the inside of which the forward-direction-side end part of the cam body gets fitted.

### TECHNICAL FIELD

The present invention relates to an electrically operated gas flow regulating valve comprising: a needle valve body axially moveable toward, or away from, a valve seat inside a valve casing; a stepping motor; and a motion conversion mechanism for axially moving the needle valve body by rotation of the stepping motor.

### BACKGROUND ART

In this kind of electrically operated gas flow regulating valve, there is known one in which the motion conversion mechanism has: cam pins fixed to the needle valve body; a guide member having formed therein axially elongated slits with which the cam pins are slidably engaged; and a tubular cam body having formed therein cam grooves which serve as spiral cam part with which the cam pins are slidably engaged (see, e.g., patent documents 1 and 2). In this arrangement, one of the guide member and the cam body is coupled to the stepping motor, and the other is arranged to be non-rotatable relative to the valve casing.

Provided that: out of (or within) axial directions, a direction in which the needle valve body approaches the valve seat is defined as a forward direction; a direction in which the needle valve body moves away from the valve seat is defined as a backward direction; a direction of rotation of the stepping motor to move the needle valve body in the forward direction is defined as a normal rotating direction; and a direction of rotation of the stepping motor to move the needle valve body in the backward direction is defined as a reverse rotating direction. Then, in a first type of electrically operated gas flow regulating valve in which the guide member is coupled to the stepping motor, the needle valve body is arranged to be moved in the forward direction or in the backward direction, as a result of rotation of the cam pins through the guide member due to the rotation of the stepping motor in the normal rotating direction or in the reverse rotating direction. In addition, in a second type of electrically operated gas flow regulating valve in which the cam body is coupled to the stepping motor, it is so arranged that, due to the rotation of the cam body by the rotation of the stepping motor in the normal rotating direction or in the reverse rotating direction, the needle valve body is moved, through the cam grooves and the cam pins, in the forward direction or in the backward direction.

Still furthermore, in the above-mentioned first type of electrically operated gas flow regulating valve, in order to couple the guide member to the stepping motor at a backward-direction-side end part thereof, the slits are left open at a forward-direction-side end part of the guide member so that the cam pins can be inserted into the slits from the forward direction side. Further, in the above-mentioned second type of electrically operated gas flow regulating valve, in order to couple the cam body to the stepping motor at a backward-direction-side end part of the cam body, the cam grooves are left open at a forward-direction-side end part of the cam body so that the cam pins are inserted into the cam grooves from the forward direction side.

By the way, in either of the first and the second electrically operated type of gas flow regulating valves, in a state of having moved the needle valve body to the stroke end in the forward direction, the stepping motor is arranged to get out of synchronization to obtain an origin (or a home position). It is to be noted here that, in the first type of electrically operated gas flow regulating valve, the slits are left open at the forward-direction-side end part of the guide member. Therefore, due to the force to be applied to the side edges of the slits via the cam pins at the time of bringing the stepping motor out of synchronization, the guide member will be deformed in such a manner that the width of the slits will gradually be widened toward the forward-direction-side end part of the guide member. As a result, the accuracy in obtaining the origin will become poorer. Also in the second type of electrically operated gas flow regulating valve, the cam grooves are left open at the forward-direction-side end part of the cam body. Therefore, due to the force to be applied to the side edges of the cam grooves through the cam pins at the time of bringing the stepping motor out of synchronization, the cam body will be deformed in such a manner that the groove width of the cam grooves will gradually be widened toward the forward-side end part of the cam body. As a result, the accuracy in obtaining the origin will become poorer.

### PRIOR ART DOCUMENT

### Patent Document

[Patent Document 1] JP-A-2018-13274

[Patent Document 2] JP-A-2020-118201

### SUMMARY

### Problems that the Invention is to Solve

In view of the above points, this invention has a problem of providing an electrically operated gas flow regulating valve which is arranged to be capable of obtaining the origin at a high accuracy by bringing the stepping motor out of synchronization.

### Means for Solving the Problems

In order to solve the above-mentioned problem, the first aspect of the invention of this application has a feature in that, in the above-mentioned first type of electrically operated gas flow regulating valve, the valve casing comprises inside thereof a deformation-restricting element for the guide member, the deformation-restricting element having a female type of fitting part into the inside of which the forward-direction-side end part of the guide member gets fitted. Further, in the above-mentioned second type of electrically operated gas flow regulating valve, the valve casing comprises inside thereof a deformation-restricting element for the cam body, the deformation-restricting element having a female type of fitting part into the inside of which the forward-direction-side end part of the cam body gets fitted

According to the first invention, when the stepping motor is brought out of synchronization, the deformation-restricting element for the guide member can restrain the guide member from being deformed in such a manner that the width of the slits becomes gradually widened toward the forward-direction-side end part of the guide member. Similarly, according to the second invention, the deformation-restricting element for the cam body can restrain the cam body from being deformed in such a manner that the width of the cam grooves become gradually widened toward the forward-direction-side end part of the cam body. Therefore, in either of the first invention and the second invention, the operation of obtaining the origin by bringing the stepping motor out of synchronization can be performed at a higher accuracy.

### BRIEF DESCRIPTIONS OF THE DRAWINGS

FIG. 1 is a sectional side view of an electrically operated gas flow regulating valve according to a first embodiment of this invention.

FIG. 2 is a sectional view of the electrically operated gas flow regulating valve sectioned along line II-II in FIG. 1.

FIG. 3 is a perspective view in an exploded state of a motion conversion mechanism disposed in the electrically operated gas flow regulating valve of the first embodiment.

FIG. 4 is a sectional side view of the electrically operated gas flow regulating valve according to the second embodiment of this invention.

### PREFERRED EMBODIMENTS FOR CARRYING OUT THE INVENTION

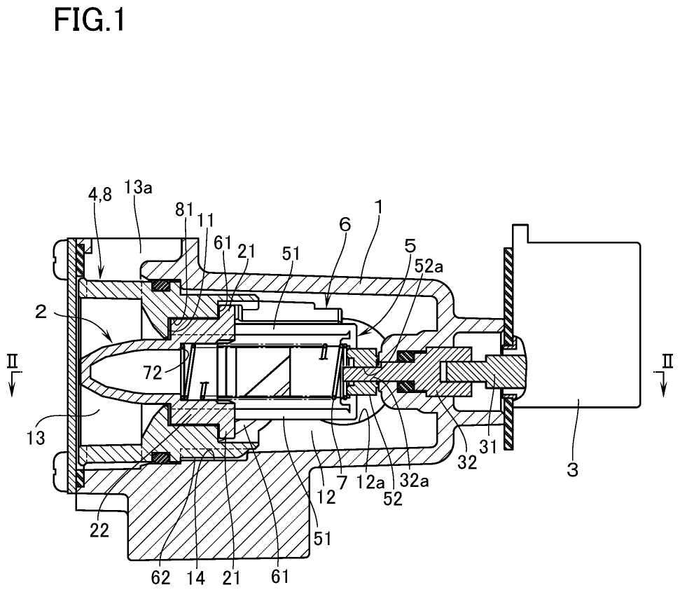

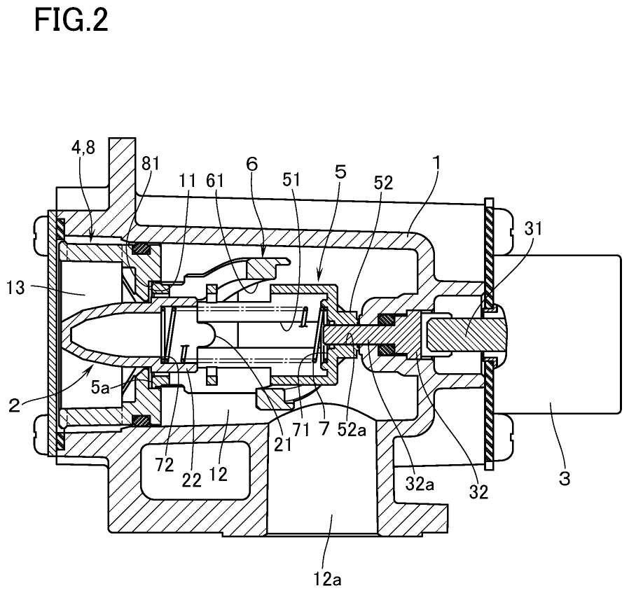

With reference to FIG. 1 and FIG. 2, an electrically operated gas flow regulating valve according to a first embodiment of this invention has: a truncated-conical needle valve body 2 axially moveable toward, or away from, a valve seat 11 inside a valve casing 1; a stepping motor 3; and a motion conversion mechanism for causing the needle valve body 2 to move axially by a rotation of the stepping motor 3. The valve casing 1 is provided, inside thereof, with a primary-side gas chamber 12 which is in communication with a gas inlet port 12a, and a secondary-side gas chamber 13 which is in communication with a gas outlet port 13a. Then, the secondary gas chamber 13 has mounted therein a valve seat member 4 having formed therein the valve seat 11 which partitions the primary-side gas chamber 12 from the secondary-side gas chamber 13.

Descriptions will hereinafter be made provided that, out of axial directions, a direction in which the needle valve body 2 approaches the valve seat 11 is defined as a forward direction; a direction in which the needle valve body 2 moves away from the valve seat 11 is defined as a backward direction; a direction of rotation of the stepping motor 3 to move the needle valve body 2 in the forward direction is defined as a normal rotating direction; and a direction of rotation of the stepping motor 3 to move the needle valve body 2 in the backward direction is defined as a reverse rotating direction.

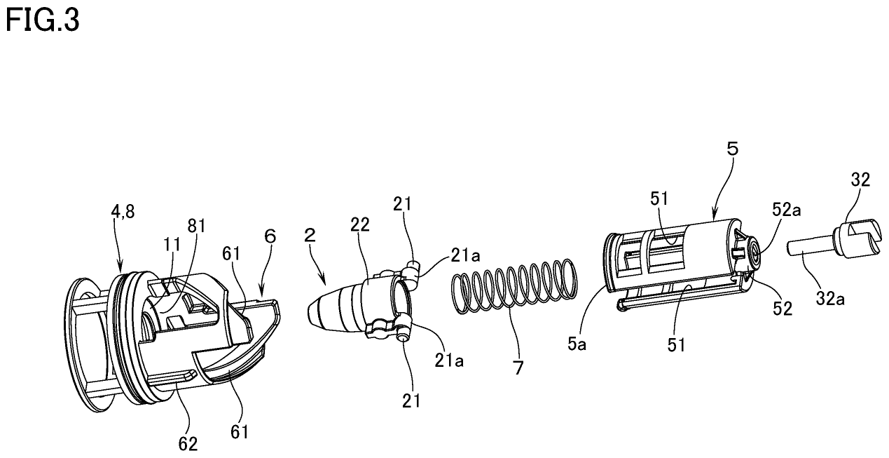

With reference also to FIG. 3, the motion conversion mechanism is provided with: cam pins 21 fixed to the needle valve body 2; a tubular guide member 5 having formed therein axially elongated slits 51 with which the cam pins 21 are slidably engaged; and a tubular cam body 6 having spiral cam parts 61 with which the cam pins 21 are engaged through the slits 51. The stepping motor 3 is disposed on an outside of a backward-direction-side end part of the valve casing 1.

The guide member 5 is coupled, at a backward-direction-side end part thereof, to the stepping motor 3. Specifically, in a boss part 52 that has been formed in a protruded manner at the backward-direction-side end part of the guide member 5, a coupling hole 52a of non-circular shape in cross section is formed. Also an axis part 32a of a connector 32, which is non-circular in cross section and which is to be connected to an output shaft 31 of the stepping motor 3, is fitted into the coupling hole 52a. According to this arrangement, the guide member 5 is coupled, through the connector 32, to the output shaft 31 of the stepping motor 3, so that the guide member 5 is rotated by the rotation of the stepping motor 3. Further, the slits 51 that are formed in the guide member 5 are left open in the forward direction at a forward-direction-side end part 5a of the guide member 5. Then, the cam pins 21 are inserted into the slits 51 from the forward direction side.

The needle valve body 2 has a tubular part 22 which is elongated in the backward direction so as to be inserted into the guide member 5. On a backward-direction-side end part of this tubular part 22 there are disposed the cam pins 21 in a manner to protrude radially outward. In addition, the base portions of the cam pins 21 have formed therein large-diameter portions 21a. These large-diameter portions 21a are slidably engaged with the slits 51 formed in the guide member 5. As a result, the needle valve body 2 is arranged to be coupled to the guide member 5 in a manner to be axially movable relative to the guide member 5 and is also to be rotatable together.

The cam body 6 is prevented from rotating relative to the valve casing 1. Specifically, by engaging a rib 62 disposed in a protruded manner on an outer periphery of the cam body 6, with a groove 14 formed on an inner circumference of the valve casing 1, the cam body 6 is prevented from rotating relative to the valve casing 1. The cam parts 61 disposed on the cam body 6 are constituted by spiral inclined-sides with which the cam pins 21 can be brought into contact, and which is inclined in the forward direction toward the normal rotating direction. Further, a spring member 7 is disposed in order to urge the cam pins 21 in the forward direction toward the cam parts 61. It is also possible to constitute the cam parts 61 by spirally shaped cam grooves. In this case, the spring member 7 is not required. In addition, in order to reduce the number of constituent parts, the cam body 6 is formed integrally with the valve seat member 4.

According to the above-mentioned arrangement, by the rotation of the cam pins 21 through the guide member 5, as a result of rotation of the stepping motor 3 in the normal rotating direction or in the reverse rotating direction, the needle valve body 2 moves in the forward direction and in the backward direction through the cam parts 61 and the cam pins 21.

By the way, due to slipping in the stepping motor 3, there is a case in which the correlation between the rotational phase of the stepping motor 3 and the axial position of the needle valve body 2 will be thrown out of synchronization. As a solution, the needle valve body 2 is moved to a stroke end in the forward direction at an appropriate timing. In this state, the stepping motor 3 is pulled (or thrown) out of synchronization, and an origin is obtained. However, the slits 51 are left open in the forward direction at the forward-direction-side end part 5a of the guide member 5. Therefore, at the time of pulling the stepping motor 3 out of synchronization, there is a possibility, due to the force to be applied through the cam pins 21 to the side edge of the slits 51, that the guide member 5 will be deformed in such a manner that the width of the slits 51 may gradually widens toward the forward-direction-side end part 5a. Once this kind of deformation has taken place, the position of the origin of the stepping motor 3 may fluctuate, resulting in a poorer accuracy in obtaining the origin.

As a solution, the valve casing 1 comprises inside thereof a deformation-restricting element 8 for the guide member 5, the deformation-restricting element 8 having a female type of fitting part 81 into the inside of which the forward-direction-side end part 5a of the guide member 5 gets fitted. In this embodiment, the valve seat member 4 has formed therein a hollow with the valve seat 11 serving as a bottom of the hollow and into which the forward-direction-side end part 5a of the guide member 5 is internally fitted. This hollow constitutes a female type of fitting part 81. And the deformation-restricting element 8 and the valve seat member 4 are integrated together.

According to the above-mentioned arrangement, when the stepping motor 3 is pulled out of synchronization, the deformation-restricting element 8 for the guide member 5 can restrain the deformation of the guide member 5, due to the force to be applied through the cam pins 21 to the side edges of the slits 51, the deformation being such that the width of the slits 51 gradually becomes larger toward the forward-direction-side end part 5a of the guide member 5. Therefore, obtaining the origin by pulling the stepping motor 3 out of synchronization can be performed at a higher accuracy.

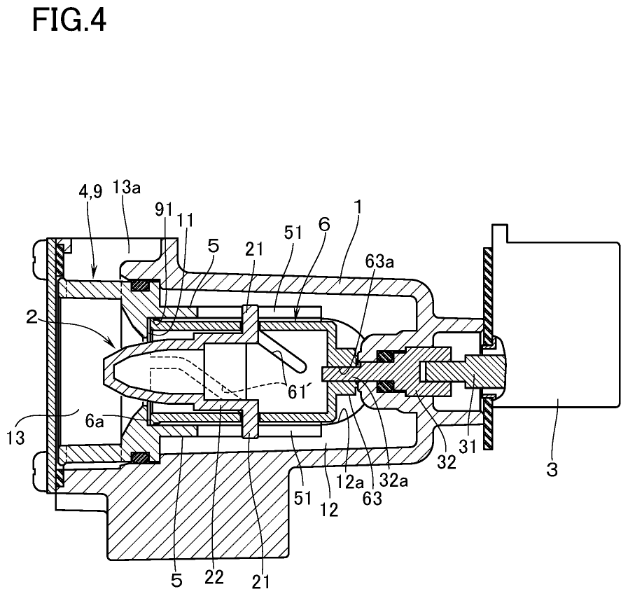

Next, descriptions will be made of a second embodiment of an electrically operated gas flow regulating valve of this invention as shown in FIG. 4. Members and parts similar to those as in the above-mentioned first embodiment have been assigned the similar reference marks as those in the first embodiment. Main difference of the second embodiment from the first embodiment is that the guide member 5 is prevented from rotating relative to the valve casing 1, and also that the cam body 6 is coupled to the stepping motor 3. By the way, the guide member 5 is formed integral with the valve seat member 4 in order to reduce the number of constituting parts. In other words, the valve seat member 4 has integrally formed therewith a pair of guide members 5, 5 which are elongated in the backward direction along circumferentially both outsides of the cylindrical cam body 6. In addition, each of the guide members 5 has formed therein axially elongated slits 51.

The cam body 6 is coupled to the stepping motor 3 at a backward-direction-side end part of the cam body 6. Specifically, a boss part 63 disposed in a protruded manner at the backward-direction-side end part of the cam body 6 has formed therein a coupling hole 63a which is non-circular in cross-section. Further, such a shaft part 32a of a connector 32 as is coupled to an output shaft 31 of the stepping motor 3 is fitted into the coupling hole 63a. According to this arrangement, the cam body 6 is coupled through the connector 32 to the output shaft 31 of the stepping motor 3 so that the cam body 6 can be rotated by the rotation of the stepping motor 3.

The cam body 6 has formed therein spiral cam grooves 61′ with which the cam pins 21 fixed to the needle valve body 2 are engaged. These cam grooves 61′ are left open in the forward direction at a forward-direction-side end part 6a of the cam body 6. In this arrangement, the cam pins 21 are inserted into the cam grooves 61′ from the forward direction side. Further, the cam pins 21 are engaged, through the cam grooves 61′, with the slits 51 that are formed in the guide member 5. According to this arrangement, due to the rotation of the cam body 6 as a result of the rotation of the stepping motor 3 in the normal direction or in the reverse direction, the needle valve body 2 moves, through the cam grooves 61′ and the cam pins 21, in the forward direction and in the backward direction.

By the way, the cam grooves 61′ are left open in the forward direction at the forward-direction-side end part 6a of the cam body 6. Therefore, when the stepping motor 3 is pulled out of synchronization in a state in which the needle valve body 2 has been moved to the normal-direction-side stroke end, there is a possibility that the cam body 6 will be deformed such that the groove widths of the cam grooves 61′ become gradually widened toward the forward-direction-side end part 6a due to the force to be applied through the cam pins 21 to the side edges of the cam grooves 61′. And once this kind of deformation has occurred, the origin of the stepping motor 3 will fluctuate, resulting in deterioration in the accuracy of obtaining the origin.

As a solution, the valve casing 1 comprises inside thereof a deformation-restricting element 9 for the cam body 6 having a female type of fitting part 91 into the inside of which the forward-direction-side end part 6a of the cam body 6 gets fitted. In this embodiment, the valve seat member 4 has formed therein a hollow with the valve seat 11 serving as a bottom of the hollow and into which the forward-direction-side end part 6a of the cam body 6 gets internally fitted, this hollow constituting the female type of fitting part 91. And the deformation-restricting element 9 is integrated with the valve seat member 4.

According to the above-mentioned arrangement, at the time of pulling out of synchronization the stepping motor 3, the deformation-restricting element 9 for the cam body 6 can restrain the cam body 6 from being deformed in such a manner that the groove width of the cam grooves 61′ becomes gradually widened toward the forward-direction-side end part 6a. Accordingly, the operation of obtaining the origin by pulling the stepping motor 3 out of synchronization can be performed at a good accuracy.

Descriptions have so far been made of embodiments of this invention with reference to the drawings, but this invention shall not be limited to the above. For example, in the above-mentioned embodiments, the deformation-restricting elements 8, 9 for the guide member 5 and for the cam body 6 are integrated with the valve seat members 4. It is, however, possible to separately provide these deformation-restricting elements 8, 9 inside the valve casing 1 independent of the valve seat members 4.

### EXPLANATION OF MARKS

1 valve casing
11 valve seat
2 needle valve body
21 cam pin
3 stepping motor
5 guide member
5a normal-direction-side end part of guide member (end part of guide member, as seen in the normal direction side)
51 slit
6 cam body
6a forward-direction-side end part of cam body (end part of cam body, as seen in the forward direction side)
61 cam part
61′ cam groove
8 deformation-restricting element for guide member (element for restricting deformation of guide member)
9 deformation-restricting element for cam body (element for restricting deformation of cam body)
81, 91 female type of fitting part

1. An electrically operated gas flow regulating valve comprising: a needle valve body axially moveable toward, or away from, a valve seat inside a valve casing; a stepping motor; and a motion conversion mechanism for axially moving the needle valve body by rotation of the stepping motor,
provided that: out of axial directions, a direction in which the needle valve body approaches the valve seat is defined as a forward direction; a direction in which the needle valve body moves away from the valve seat is defined as a backward direction; a direction of rotation of the stepping motor to move the needle valve body in the forward direction is defined as a normal rotating direction; and a direction of rotation of the stepping motor to move the needle valve body in the backward direction is defined as a reverse rotating direction,
the motion conversion mechanism having: cam pins fixed to the needle valve body; a guide member having formed therein axially elongated slits with which the cam pins are slidably engaged, the guide member being coupled to the stepping motor; a cylindrical cam body having formed spirally shaped cam parts with which the cam pins are engaged, the cam body being prevented from rotating relative to the valve casing, the motion conversion mechanism being so arranged that, by the rotation of the cam pins through the guide member as a result of rotation of the stepping motor in the normal rotating direction or in the reverse rotating direction, the needle valve body is moveable, through the cam part and the cam pins, in the forward direction or in the backward direction;
the guide member being coupled, at a backward-direction-side end part of the guide member, to the stepping motor and, at a forward-direction-side end part of the guide member, the slits are left open in the forward direction so that the cam pins can be inserted into the slits from the forward direction side;
wherein the valve casing comprises inside thereof a deformation-restricting element for the guide member, the deformation-restricting element having a female type of fitting part into the inside of which the forward-direction-side end part of the guide member gets fitted.

2. An electrically operated gas flow regulating valve comprising: a needle valve body axially moveable toward, or away from, a valve seat inside a valve casing; a stepping motor; and a motion conversion mechanism for axially moving the needle valve body by rotation of the stepping motor;
provided that: out of axial directions, a direction in which the needle valve body approaches the valve seat is defined as a forward direction; a direction in which the needle valve body moves away from the valve seat is defined as a backward direction; a direction of rotation of the stepping motor to move the needle valve body in the forward direction is defined as a normal rotating direction; and a direction of rotation of the stepping motor to move the needle valve body in the backward direction is defined as a reverse rotating direction,
the motion conversion mechanism having: cam pins fixed to the needle valve body; a guide member having formed therein axially elongated slits with which the cam pins are slidably engaged, the guide member being prevented from rotating relative to the valve casing; and a cylindrical cam body having formed therein spirally shaped cam grooves with which the cam pins are engaged, the cam body being coupled to the stepping motor, the motion conversion mechanism being so arranged that, as a result of rotation of the stepping motor in the normal rotating direction or in the reverse rotating direction, the needle valve body is moved, through the cam grooves and the cam pins, in the forward direction or in the backward direction;
the cam body being coupled, at a backward-direction-side end part of the cam body, to the stepping motor and, at a forward-direction-side end part of the cam body, the cam grooves are left open in the forward direction so that the cam pins can be inserted into the cam grooves from the forward direction side;
wherein the valve casing comprises inside thereof a deformation-restricting element for the cam body, the deformation-restricting element having a female type of fitting part into the inside of which the forward-direction-side end part of the cam body gets fitted.
